(19) United States
(12) Patent Application Publication
(10) Pub. No.: US 2007/0215220 A1
(43) Pub. Date: Sep. 20, 2007

(54) System for direct transfer of gas from a supply source to a portable cylinder and method for same

(76) Inventor: Thomas K. Bannon, St. Louis, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/385,232

(22) Filed: Mar. 20, 2006

(51) Int. Cl. F16K 1/30

(52) U.S. Cl. 137/614.2

(57) ABSTRACT

A system and method of transferring, by a patient, high purity gas from a supply source to a portable cylinder. The system comprises a regulator that operatively connects to the supply source that stores the high purity gas. A cylinder valve removeably connects with the outlet of the regulator while a residual pressure valve operatively connects to the cylinder valve. The residual pressure valve includes a chamber in communication with the cylinder valve, wherein a piston assembly separates the chamber into a high pressure area and a low pressure area. During a fill process, the portable cylinder removeably connects to the valve outlet such that the high purity gas flows directly into the chamber via the regulator and cylinder valve to slide the piston assembly within the chamber to allow the flow of the high purity gas through the chamber and into the portable cylinder. During a non-fill process, pressure of residual gas of the high purity gas slides the piston assembly in contact with the cylinder valve to seal the chamber from atmospheric contaminants while maintaining a residual pressure of the residual high purity gas within the portable cylinder.

### CROSS REFERENCE TO RELATED APPLICATIONS

Not Applicable

### STATEMENT REGARDING FEDERALLY SPONSORED RESEARCH

Not Applicable.

### BACKGROUND OF THE DISCLOSURE

The present disclosure relates to a system having a manifold which transfers gas from a large cylinder into portable cylinders, in particular, the present disclosure relates to repeatedly filling high purity oxygen from a home based supply cylinder into a portable cylinder without having to purge/clean the portable cylinder prior to subsequent and repeated fill cycles of the portable cylinder.

Due to a variety of health reasons, numerous patients rely upon concentrated oxygen supplies for assisted breathing for in-home use and personal activity use.

The oxygen for direct consumption by the patient is typically supplied by regulated compressed gas cylinders (bottled oxygen); or by liquid oxygen systems or by concentrators. Concentrators only supply oxygen purity levels of 93%, as compared to 99+% for bottled oxygen. Purity of the concentrator also relies on a properly functioning unit as controlled by the patient. Furthermore, concentrators comprise bulky equipment that takes up space within a patient's home. Additionally, concentrators generate noise when drawing in ambient air and when discharging oxygen into the portable cylinder.

Although cylinders of liquid oxygen systems can be re-charged/filled in the home, a certified supplier/technician must visit the patient's home to conduct each re-fill. Furthermore, liquid oxygen systems are expensive to initially order and are expensive to maintain.

Current compressed gas cylinders can contain high purity oxygen (liquid and concentrated), wherein the Food and Drug Administration regulates these cylinders as a drug. Furthermore, current gas cylinders are sold in commerce with non-interchangeable, dedicated Compressed Gas Association (CGA) connections. As such, personnel for regulated oxygen suppliers fill the heavy and large reservoir/supply cylinders and the portable cylinders. The large, non-portable reservoir cylinders and the small portable cylinders are then delivered to the patient's home. The heavy supply cylinders are only for in-home use, while the small portable cylinders are used for travel or other activities outside the home.

Once the patient exhausts the oxygen supply from the portable cylinder, the portable cylinder must be delivered to and serviced by the regulated supplier to properly purge and clean the used portable cylinder. The used portable cylinder requires servicing due to potential contamination issues. When the pressure in the portable cylinder is depleted (i.e., the portable cylinder is virtually empty) atmospheric air laden with impurities, such as water vapor, can be introduced into the cylinder and, consequently contaminate the oxygen contained therein or contaminate the oxygen that will fill during the next charging of that portable cylinder. Special procedures are required to empty and to vacuum the contaminated cylinder prior to any refilling at the cylinder

Unfortunately, there presently exists no compact and cost-effective system to enable a patient to personally fill or refill a portable oxygen cylinder from a large in-home oxygen cylinder for repeated use of. the portable oxygen cylinder by the patient.

### BRIEF DESCRIPTION OF THE SEVERAL VIEWS OF THE DRAWINGS

Illustrative embodiments of the present disclosure are shown in the following drawings which form a part of the specification:

FIG. 1 illustrates a system constructed in accordance with and embodying the present disclosure showing a supply cylinder, a regulator, a cylinder valve and a portable cylinder;

FIG. 2 illustrates in a side sectional view the regulator of FIG. 1 showing a safety check valve, a valve aperture, a channel of a key assembly and a bypass regulator constructed in accordance with and embodying the present disclosure;

FIG. 3A illustrates a partial top view of a rotatable yoke assembly in a closed position;

FIG. 3B illustrates the rotatable yoke assembly of FIG. 3A in an open position;

FIG. 4A illustrates in a side elevational view the cylinder valve of FIG. 1 showing an inlet and a portion of key assembly constructed in accordance with and embodying the present disclosure;

FIG. 4B illustrates in a cross sectional view the cylinder valve of FIG. 4A;

FIG. 5 illustrates in a partial sectional view the cylinder valve connected to the portable cylinder showing a residual pressure valve in an open condition in accordance with and embodying the present disclosure;

FIG. 6 illustrates in a partial sectional view the cylinder valve connected to the portable cylinder showing the residual pressure valve in a closed condition in accordance with and embodying the present disclosure;

FIG. 7 illustrates a flowchart showing steps of a method of repeatedly filling a portable cylinder with a high purity gas;

FIG. 8 illustrates another flowchart showing steps of a method of repeatedly filling a portable cylinder with a high purity gas.

Corresponding reference characters indicate corresponding parts throughout the several views of the drawings.

### SUMMARY OF THE DISCLOSURE

The present disclosure relates to a system and method that allows a patient to repeatedly transfer high purity oxygen from a home based supply cylinder into a portable cylinder without having to purge/clean the portable cylinder prior to subsequent and repeated filling cycles of the portable cylinder.

The system comprises a regulator that removeably connects to a body of the supply cylinder that stores the high purity oxygen. A cylinder valve of the system connects with the outlet of the regulator while a residual pressure valve operatively connects to the cylinder valve. The residual pressure valve includes a chamber in communication with the cylinder valve, wherein a piston assembly separates the chamber into a high pressure area and a low pressure area.

During a fill process, the portable cylinder removeably connects to a valve outlet of the cylinder valve such that the high purity oxygen flows directly into the chamber via the regulator and cylinder valve to slide the piston assembly within the chamber to allow the flow of the high purity oxygen through the chamber and into the portable cylinder. During a non-fill process, pressure of residual high purity oxygen slides the piston assembly in contact with the cylinder valve to seal the chamber from atmospheric contaminants while maintaining a residual pressure of the residual high purity oxygen within the portable cylinder. As such, the residual pressure valve thereafter retains the desired amount of residual pressurized gas in the portable cylinder to minimize backfill contamination between subsequent fill cycles.

### DETAILED DESCRIPTION OF EMBODIMENTS OF THE DISCLOSURE

The following detailed description illustrates the disclosure by way of example and not by way of limitation. The description clearly enables one skilled in the art to make and use the disclosure, describes several embodiments, adaptations, variations, alternatives, and uses of the disclosure, including what is presently believed to be the best mode of carrying out the disclosure.

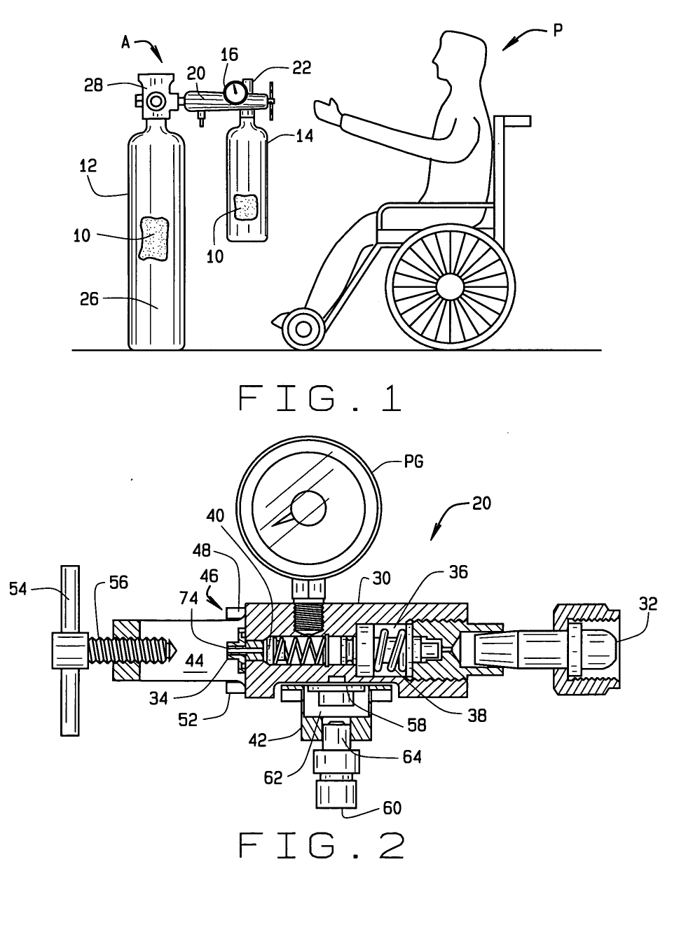

Referring to the drawings, the system A for transferring pressurized gas 10 from a supply source 12 to a portable cylinder 14 for repeated personal use of the portable cylinder 14 by a patient P is shown in FIG. 1. In One embodiment, the supply source 12 comprises a gas supply cylinder and the portable cylinder 14 comprises a portable gas cylinder. The system A enables patients P receiving oxygen therapy to safely fill a small, portable, high pressure gaseous cylinder from a large reservoir or supply cylinder in the patient's home. As such, the present system A allows the patient P to refill the portable cylinder 14 with high purity oxygen without having to clean/purge the portable cylinder 14 and without having to send the used portable cylinder 14 to a regulated supplier for purging and re-filling. For descriptive purposes, the patient P may include the person receiving the oxygen therapy. Other personnel such as home assistance personnel, health care personnel and family members may use the present system A for the benefit of the patient.

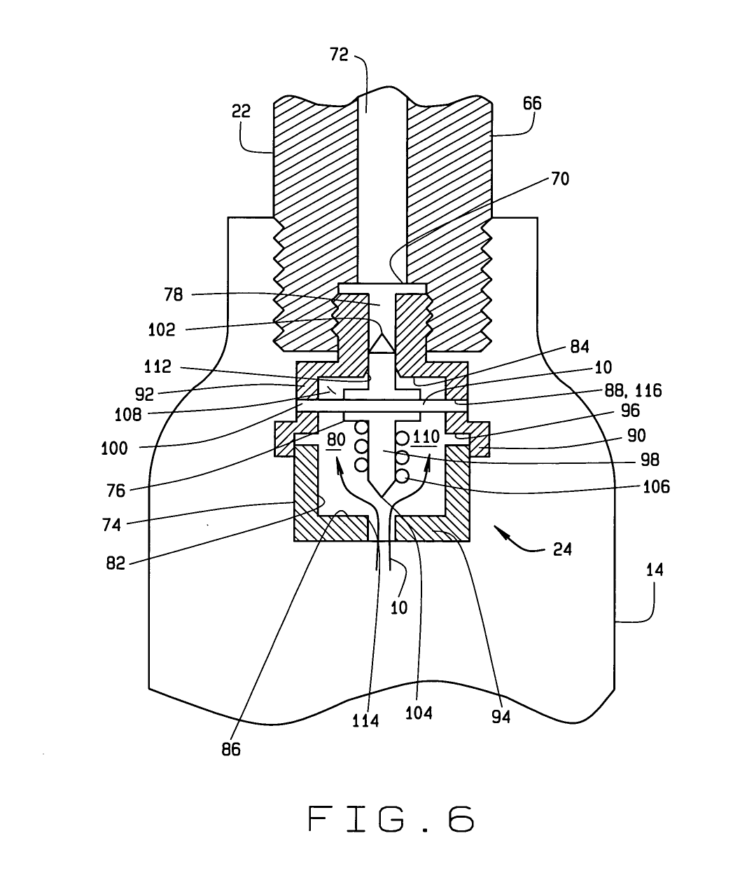

As shown in FIG. 1, the system A comprises the supply source 12 and the portable cylinder 14. The supply source 12 typically includes the “H” type gas cylinder as classified by the compressed gas industry. The supply source 12 has a capacity up to and including 3,000 psi of compressed high purity gas. Preferably, the supply source 12 contains the pressurized gas 10 at a pressure above atmospheric pressure. A safety mechanism such as upper and lower chains secured to a substantially fixed surface or a cylinder cart maintains the supply source 12 in an upright and secure position. The portable cylinder 14 typically includes the “M6” type cylinder as classified by the compressed gas industry. The portable cylinder 14 has a capacity up to and including 2,600 psi. The system A of FIG. 1 further comprises a regulator 20, a cylinder valve 22 and a residual pressure valve 24 (FIGS. 5 and 6).

The supply source 12 includes a body 26 and a valve assembly 28 (FIG. 1). The body 26 is configured to hold an amount of the pressurized gas 10. The valve assembly 28 is configured to receive and discharge the amount of pressurized gas 10 of the body 26. In one embodiment, the pressurized gas 10 comprises high purity oxygen having a purity level of at least 93%. In another embodiment, the pressurized gas 10 comprises high purity oxygen having a purity level of at least 99%.

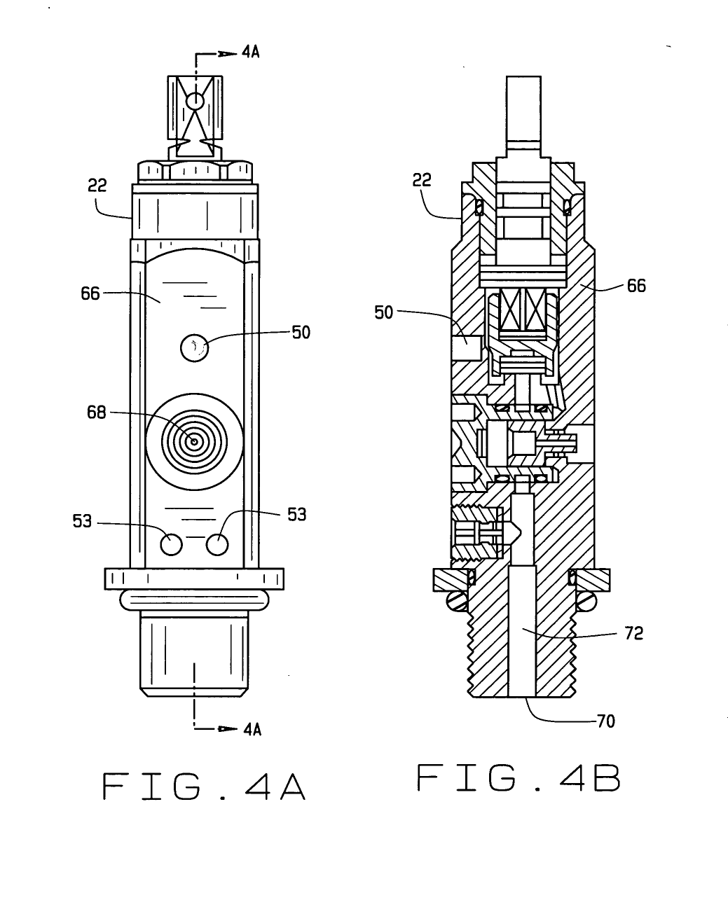

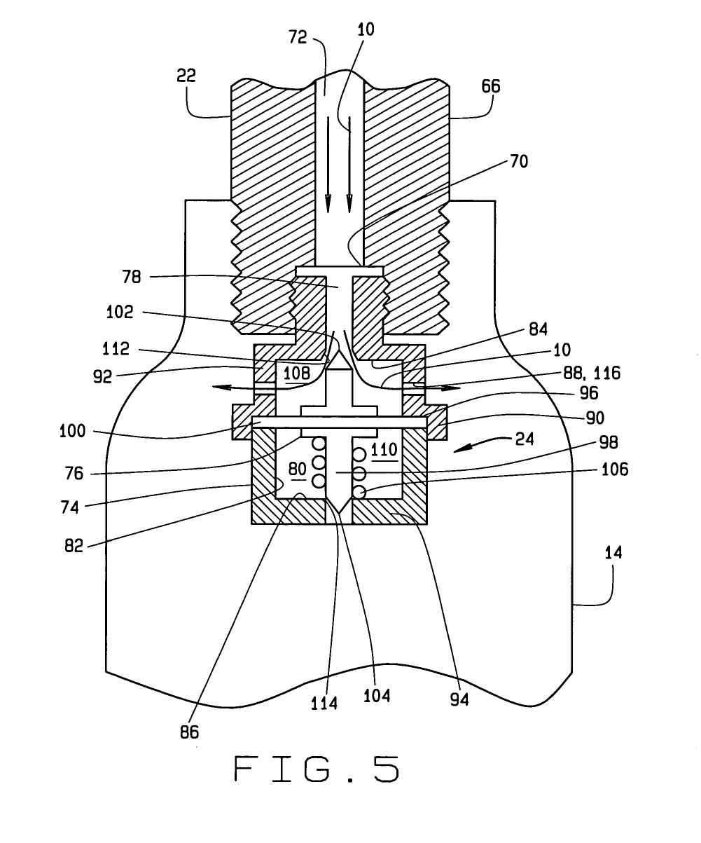

Turning to FIG. 2, the regulator 20 includes a regulator body 30 which has an inlet 32, an outlet 34, a gas flow path 36 in communication with the inlet 32 and outlet 34, a pressure gauge PG in communication with the gas flow path 36, an internal gas flow control mechanism 38, a safety shutoff check valve 40, a bypass regulator 42, a valve aperture 44 defined through the regulator body 30, a key assembly 46 having a pin 48 and a channel 50 (FIG. 4), extensions 52 and a yoke assembly 54.

The inlet 32 is capable of removeably connecting to the supply source 12 via the valve assembly 28. The inlet 32 includes a connection such as a threaded coupling that removeably connects with the valve assembly 28 of the supply source 12 (FIG. 1). The inlet 32 includes an orifice that positions the valve assembly 28 and gas flow path 36 in communication with each other. The internal flow control mechanism 38 of the gas flow path 36 reduces or “steps down” the pressure of the pressurized gas 10 discharged from the supply source 12 such that a reduced pressure of the pressurized gas 10 exits the outlet 34 of the regulator body 30. In one embodiment, the flow control mechanism 38 reduces the pressure of the pressurized gas from 3,000 to 2,200 psi. As will be appreciated, the safety check valve 40 prevents the flow of the pressurized gas 10 through the outlet 34 of the regulator body 30 when the cylinder valve 22 (FIG. 4) disconnects from the regulator 20. To properly position the safety check valve 40, the gas flow path 36 reduces or chamfers towards the outlet 34. The gas flow path 36 also includes an orifice assembly (not shown) that regulates the flow of the pressurized gas 10 at a specific rate to reduce heat build up in the portable cylinder 14 and cylinder valve 22.

As shown in FIG. 2, the valve aperture 44 is positioned adjacent to the outlet 34 of the regulator body 30. The regulator body 30 positions the yoke assembly 54 opposite the outlet 34 and across the valve aperture 44. As is appreciated, the yoke assembly 54 includes a driver 56 that traverses across the valve aperture 44 and toward the outlet 34. The yoke assembly 54 is rotatable with respect to the valve outlet, wherein the yoke assembly 54 rotates between a closed position and an open position such that the open position exposes the outlet 34 for connection to the cylinder valve 22, and the closed position secures the cylinder valve 22 to the outlet 34.

The regulator body 30 further positions the pin 48 of the key assembly 46 above the valve aperture 44 while positioning the extensions 52 below the valve aperture 44. The pin 48 and the channel 50 of the key assembly 46 prevent non-compliant cylinder valves from connecting with the regulator 20. In other words, the key assembly 46 connects together the cylinder valve 22 and the regulator 20 such that the pin 48 matingly engages the channel 50 in a predetermined orientation.

The regulator assembly 42 includes another inlet 58, outlet 60, flow path 62 and flow control mechanism 64. The bypass inlet 58 communicates with the gas flow path 36 of the regulator body 30 wherein the bypass control mechanism 64 again reduces the pressure of the pressurized gas 10 as the pressurized gas 10 exits the outlet 60 of the regulator assembly 42. In one embodiment, the regulator assembly 42 reduces the pressure of the pressurized gas 10 to a range of 22 to 50 psi. The regulator assembly 42 allows a patient P to connect a mask to the bypass outlet 60 via tubing (not shown) and to directly access the pressurized gas 10 stored in the supply source 12 while the regulator 20 remains connected to the supply source 12. As such, the regulator assembly 42 allows the patient P to directly access the pressurized gas 10 of the supply source 12 without having to use the portable cylinder 14. Accordingly, if the electronic power goes out within the home, the patient P can access the high purity gas via the regulator assembly 42.

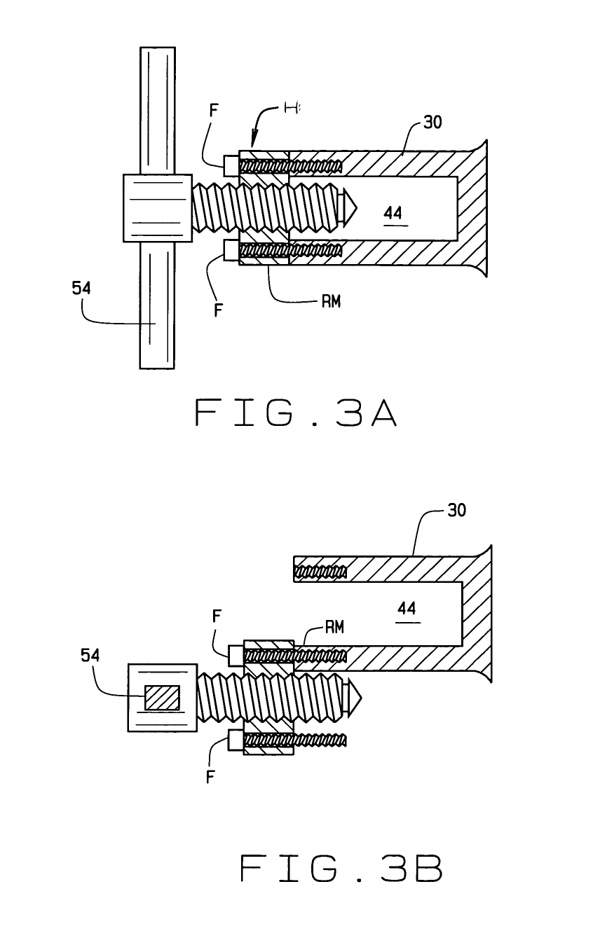

Turning to FIGS. 3A and 3B, in one embodiment, the regulator body 30 includes a hinge assembly H positioned on the valve aperture 44 and near the yoke assembly 54. The hinge assembly H includes a rotating member RM and at least one fastener F. In this embodiment, the yoke assembly 54 rotates with the rotating member RM to fully expose the valve aperture 44. As such, the portion of the regulator body 30 associated with the yoke assembly 54 is separate from the remainder of the regulator body 30. In the closed position (FIG. 3A), the at least one fastener F fastens the yoke assembly 54 to the regulator body 30. In this closed position, the yoke assembly 54 secures the cylinder valve 22 to the outlet 34. In the open position (FIG. 3B), the at least one fastener F releases the yoke assembly 54 from the regulator body 30 to allow the yoke assembly 54 to rotate around the rotating member RM to expose the valve aperture 44 for eventual connection within the cylinder valve 22.

Referring to FIGS. 4A and 4B, the cylinder valve 22 is configured to insert within the valve aperture 44 of the regulator body 30 (FIGS. 1 and 2) for operative connection with the regulator 20. The cylinder valve 22 includes a valve body 66 having a valve inlet 68, a valve outlet 70, and a valve gas flow path 72 in communication with the valve inlet 68 and the valve outlet 70. The valve inlet 68 is configured to removeably connect with the outlet 34 of the regulator 20 while the valve outlet 70 is configured to removeably connect with the portable cylinder 14. As shown, the valve inlet 68 and valve outlet 70 allow gas flow in and out of the cylinder valve 22 depending on whether the patient P is charging or discharging the portable cylinder 14. The valve body 66 further includes the channel 50 of the key assembly 46 and also includes extension channels 53. Furthermore, as shown, the channel 50 is positioned above the valve inlet 68 while the extension channels 53 are positioned below the valve inlet 68.

When the cylinder valve 22 inserts within the valve aperture 44 (FIG. 1), the key assembly 46 connects together the cylinder valve 22 and the regulator 20 by insertion of the pin 48 within the channel 50. As noted, the key assembly 46 allows the cylinder valve 22 and the regulator 20 to connect with each other. A non-compliant cylinder valve cannot connect with the regulator 20 since the pin 48 would abut against the non-compliant cylinder valve.

When the regulator 20 and cylinder valve 22 are allowed to connect via the key assembly 46, the extensions 52 (FIG. 2) mate with the extension channels 53. Compressed gas industry standards require cylinder valves 22 to incorporate two extensions 52 while the regulator 20 incorporates two channels 53 so that only a proper type of cylinder valve 22 connects with the corresponding type of regulator 20 via the mating/connection of the extensions 52 and channels 53. Since the present disclosure relates to oxygen, extensions 52 are classified as CGA870:O₂. Once the pin 48 and channel 50 of the key assembly 46 mate and the extensions 52 and the valve channels 53 mate, the valve inlet 68 removeably connects with the outlet 34 of the regulator body 30.

As shown in FIG. 5, the residual pressure valve 24 operatively connects to the portable cylinder 14 via the cylinder valve 22. In this embodiment, the residual pressure valve 24 partially extends within the cylinder valve 22. In another embodiment (not shown), the residual pressure valve 24 is fully embedded (i.e., built within) the cylinder valve 22. The residual pressure valve 24 includes a residual body 74 and a piston assembly 76. The residual pressure valve 24 is calibrated to automatically stop the flow of the pressurized gas 10 from the portable cylinder 14 at a desired pressure level. In one embodiment, the desired pressure level is at least atmospheric pressure. The residual body 74 has a flow channel 78 and a chamber 80 in communication with the flow channel 78.

The flow channel 78 removeably connects with the valve outlet 70 of the cylinder valve 22. As shown, in an embodiment, the flow channel 78 and the valve outlet 70 include threaded connections that mate with each other. This connection positions the gas flow path 72 in communication with the chamber 80 via the flow channel 78. Once the residual pressure valve 24 connects with the cylinder valve 22, the cylinder valve 22 removeably connects with an outlet of the portable cylinder 14 via connections such as threaded connections. As such, the residual pressure valve 24 is removeably insertable within the portable cylinder 14 via the cylinder valve 22.

The chamber 80 has opposing side walls 82, a top wall 84 and a bottom wall 86. Each wall has a gas flow port 88 defined therethrough. In one embodiment, the chamber 80 comprises separate portions such as side portions 90, a top portion 92 and a bottom portion 94 wherein small inserts 96 exist between the side portions 90 and the bottom portion 94.

The piston assembly 76, which is slidable within the chamber 80, has a rod 98, a diaphragm member 100, a first stop 102, a second stop 104 and a bias member 106. The diaphragm member 100 is positioned around the rod 98 and extends outwardly to insert within the inserts 96 of the chamber portions 92, 94. As such, the diaphragm member 100 separates the chamber 80 into a high pressure area 108 and a low pressure area 110. The rod 98 positions the first stop 102 and the second stop 104 at opposing ends of the rod 98. As shown in FIG. 5, the first stop 102 is positioned in alignment with but separate from a top gas flow port 112 while the second stop 104 is seated within a bottom gas flow port 114 in order to seal the low pressure area 110 of the chamber 80 from the interior of the portable cylinder 14. The bias member 106, meanwhile, connects around the portion of the rod 98 positioned within the low pressure area 110 of the chamber 80 (i.e. below the diaphragm member 100).

During a fill process as shown in FIG. 5, the inlet 32 of the regulator 20 connects to the supply source 12 while the outlet 34 of the regulator 20 removeably connects to the cylinder valve inlet 68. The cylinder valve outlet 70 removeably connects to the portably cylinder 14 such that the pressurized gas 10 flows from the supply source 12 through the regulator 20, through the cylinder valve 22, and into the portable cylinder 14. The residual pressure valve 24 thereafter retains the desired pressure level of residual pressurized gas 10 in the portable cylinder 14 to minimize backfill contamination between subsequent fill cycles for the portable cylinder 14. In one embodiment, the residual pressure valve 24 eliminates the potential for backfill contamination. In particular, the pressurized gas 10 flows through the flow channel 78 and against the first stop 102 and diaphragm member 100 to displace the first stop 102 and diaphragm member 100 against the bias member 106. The pressure of the gas flow further seats the second stop 104 within the bottom gas flow port 114. In this position of the piston assembly 76, the high pressure gas 10 flows through the side gas flow ports 116 and into the portable cylinder 14. Once the portable cylinder 14 is full as noted by a pressure gauge positioned on the exterior of the regulator 20, the cylinder valve 22 disconnects from the regulator 20 so that the patient P can use the portable cylinder 14. The patient P then uses the stored pressurized gas 10 within the portable cylinder 14 as will be discussed.

Turning to FIG. 6, during use of the portable cylinder 14 and/or a non-fill process of the portable cylinder 14, the internal pressure of the residual pressurized gas 10 and the bias member 106 (via the internal pressure) move the diaphragm member 100 out of the inserts 96 of the chamber 80 and upward in contact with the side gas flow ports 116. Additionally, the pressure of the residual pressurized gas 10 and the bias member 106 move the second stop 104 away from the bottom gas flow port 114 while seating the first stop 102 within the top gas flow port 112. As such, the seated first stop 102 and the diaphragm member 100 seal the chamber 80 from atmospheric contaminates. The residual pressurized gas 10 maintains a residual pressure within the low pressure area 110 of the chamber 80. This residual pressure is higher than the ambient pressure exposed to the exterior of the portable cylinder 14. Accordingly, this residual pressure is the desired pressure level (i.e., at least atmospheric pressure).

The gas transfer system A allows for the transfer of the pressurized gas 10 from the gas supply cylinder 12 to the portable cylinder 14 to fill the portable cylinder 14. The residual pressure valve 24 thereafter retains desired pressure level of the residual pressurized gas in the portable cylinder 24 to minimize backfill contamination of atmospheric contaminants between subsequent fill cycles at the portable cylinder 14. In one embodiment, the residual pressure valve 24 retains the desired pressure level in the portable cylinder 14 to allow only a known amount of backfill contamination into the portable cylinder between subsequent fill cycles of the portable cylinder. In an embodiment, the known amount of backfill contamination comprises 1% of the amount of the pressurized gas 10 within the portable cylinder 14.

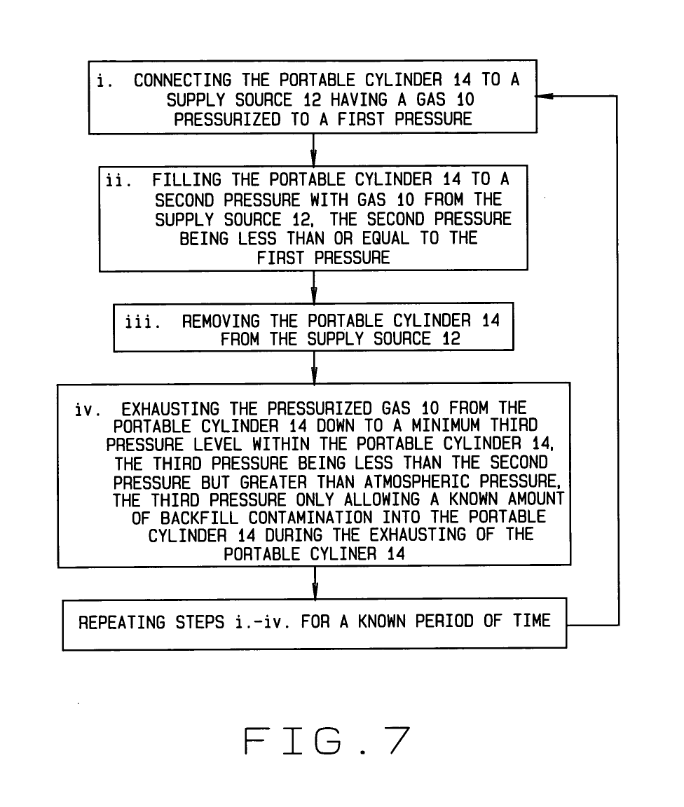

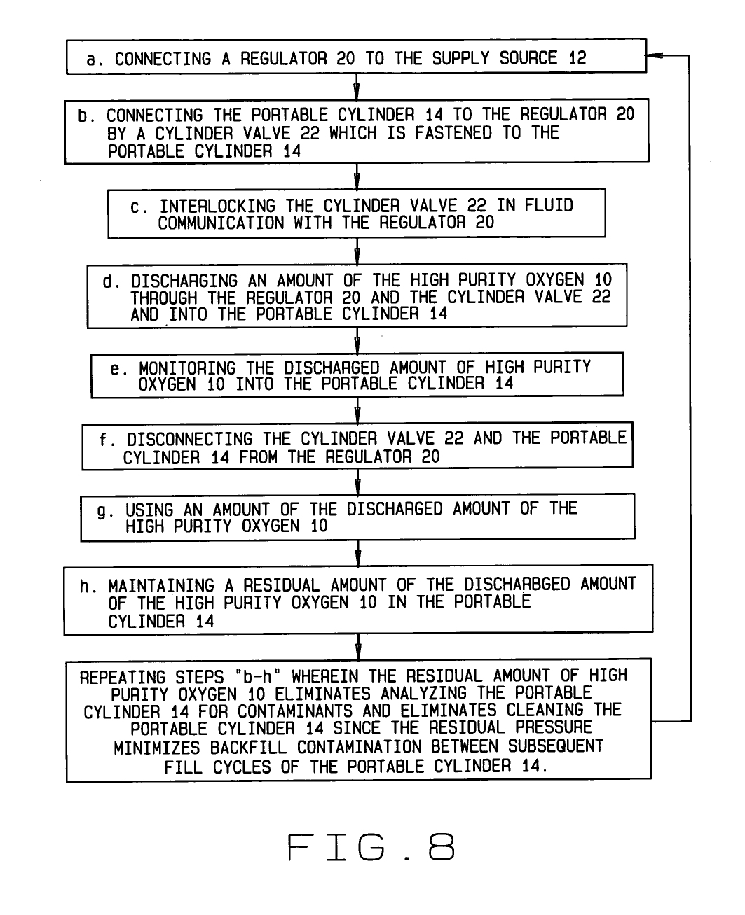

Turning to FIG. 7 and referring to FIGS. 1-6, the present disclosure provides a method for the patient P to repeatably fill, in the home environment, the portable cylinder 14 with high purity oxygen 10 that is stored in the supply source 12. The present disclosure also provides a method for the patient P to repeatably use the portable cylinder 14 subsequent any filling of the portable cylinder 14 with another amount of high purity oxygen 10 of the supply source 12. The method of the present disclosure eliminates any cleaning and/or purging of the portable cylinder 14 prior to each subsequent re-filling of the portable cylinder 14. As such, the system A eliminates any purity analysis with respect to the portable cylinder 14.

During use, the present disclosure provides a method of repeatably filling a portable gas cylinder 14 without the need for purging or evacuating the portable gas cylinder 14 during each fill cycle subsequent an initial fill cycle. At a regulated facility, the oxygen supplier connects the residual pressure valve 24 to the cylinder valve 22 by mating together the flow channel 78 of the residual pressure valve 24 and the outlet 70 of the cylinder valve 22. Once the residual pressure valve 24 connects to the cylinder valve 22, the oxygen supplier connects together the cylinder valve 22 and the portable cylinder 14 mating the outlet 70 of the cylinder valve 22 with the top connection of the portable cylinder 14. This connection positions the residual pressure valve 24 within the interior of the portable cylinder 14. As previously noted, the residual pressure valve 24 may be built within the cylinder valve 22.

Once the residual pressure valve 24 is positioned with the portable cylinder 14, the oxygen supplier then purges and evacuates the portable gas cylinder 14. After this procedure, the oxygen supplier performs a fill cycle to fill the portable gas cylinder 14 with the pressurized gas 10.

An example of the fill cycle comprises connecting the portable gas cylinder 14 to the supply source 12 having the pressurized gas 10 pressurized to a first pressure that is greater than atmospheric pressure. In one embodiment, the first pressure has a value up to and including 3,000 psi. The fill cycle then comprises filling the portable gas cylinder 14 to a second pressure from the supply source 12. The second pressure is less than or equal to the first pressure. In one embodiment, the second pressure has a value up to and including 2,200 psi. Then the cycle comprises removing the portable cylinder 14 from the supply source 12 and exhausting the pressurized gas 10 from the portable gas cylinder 14 down to a minimum third pressure level within the portable gas cylinder 14. This third pressure level is less than the second pressure level but greater than atmospheric pressure. This third pressure only allows the known amount of backfill contamination into the portable gas cylinder 14 during the exhausting of the portable gas cylinder 14. In an embodiment, the known amount of backfill contamination comprises 1% of the amount of the pressurized gas 10 within the portable cylinder 14.

This fill cycle maybe repeated for a known period of time. During this known period of time, the known amount of backfill contamination remains constant. In one embodiment, the known period of time comprises five (5) years from the date of manufacture of the portable cylinder 14. The portable cylinder 14 may include an inscription of the known period of time on the neck of the portable cylinder 14. Furthermore, the instructions for the portable cylinder 14 may include an inscription of the known period of time. Thus, the method of the present disclosure provides for repeatably filling the portable gas cylinder 14 without contaminating the gas cylinder 14 and without purging or evacuating the portable gas 14 during each fill cycle as performed by the patient P.

In another example, the method comprises connecting the residual pressure valve 24 with the cylinder valve 22. The residual pressure valve 24 is capable of automatically stopping the flow of pressurized gas 10 out of the portable gas cylinder 14 when the pressure in the portable gas cylinder 14 drops below the desired pressure level or below atmospheric pressure. Then the method comprises connecting the cylinder valve 22 to the portable gas cylinder 14 wherein the cylinder valve 22 is capable of opening and closing to controllably allow pressurized gas 10 to flow into and out of the portable gas cylinder 14.

Next, the method comprises connecting the regulator 20 to the cylinder valve 22 and to the supply source 12. The regulator 20 is capable of regulating a flow of the pressurized gas 10 from the supply source 12 into the portable gas cylinder 14. Once the cylinder valve 24 is open, the regulator 20 controllably fills the portable gas cylinder 14 with the desired amount of pressurized gas from the supply source 10. Once filled, the cylinder valve 22 is closed and the portable gas cylinder 14 is disconnected from the regulator 20. Once the portable gas cylinder 14 is disconnected from the regulator 20, the cylinder valve 22 is opened to release the pressurized gas 10 from within the portable gas cylinder 14. As such, the portable cylinder 14 has been evacuated prior to any connection of the portable cylinder 14 to the regulator 20 prior to any initial use by the patient P of the portable cylinder 14.

In another example, the oxygen supplier delivers the large supply source 12 (charged with the pressurized gas 10) and at least one portable cylinder 14 to the patient P. The portable cylinder 14 may be delivered to the patient P in a full condition, an empty condition or a partially full condition. In one embodiment, the portable cylinder 14 in the partially full condition is filled to a capacity of 40 psi or less. In this partially full capacity, the oxygen supplier can deliver/ship the portable cylinders 14 as non-hazardous cargo.

At the patient's home, the supply source 12 is safely secured. A patient P or the oxygen supplier connects the regulator 20 to the supply source 12. The regulator 20 operatively connects to the body 26 of the supply source 12, wherein the inlet 32 of the regulator 20 removeably connects with the valve assembly 28 of the supply source 12. At this point, the valve assembly 28 of the supply source 12 remains closed. The patient P then conveniently slides the cylinder valve 22 within the valve aperture 44 of the regulator body 30. Alternatively, in an embodiment, the patient P rotates the yoke assembly 54 to the open position to expose the valve aperture 44. In this open position, the patient P conveniently inserts the cylinder valve 22 within the valve aperture 44.

The patient P then rotates the yoke assembly 54 to the closed position.

In moving the cylinder valve 22 within the valve aperture 44, the patient P aligns the extension channels 53 on the cylinder valve 22 opposite the extensions 52 of the regulator 20. The patient P further aligns the channel 50 of the key assembly 46 positioned on the cylinder valve 22 in alignment with the pin 48 of the key assembly 46 positioned on the regulator 20. Once these components are aligned, the patient P easily mates the channel 50 with the pin 48 and the extensions 52 with the extension channels 53 to connect the outlet 34 of the regulator body 30 with the inlet 68 of the regulator valve 22. Since the key assembly 46 matches the appropriate cylinder valve 22 with the regulator 20, the key assembly 46 prevents the patient P from connecting the regulator 20 with a non-compliant cylinder. As such the key assembly 46 interlocks the cylinder valve 22 in fluid communication with the regulator 20.

As noted, the combination of the cylinder valve 22, residual pressure valve 24 and the portable cylinder 14 are patient specific due to the proprietary mating of the key assembly 46. When the inlet 68 of the cylinder valve 22 connects with the outlet 34 of the regulator body 30, the safety check valve 40 of the regulator body 30 moves away from the outlet 34 and toward the gas flow control mechanism 38 of the regulator body 30. As such, the gas flow path 36 is continuous from the supply source 12 to the cylinder valve 22.

Once the cylinder valve 22 is connected to the regulator 20, the patient P slowly opens the valve assembly 28 of the supply source 12. The valve assembly 28 discharges the high purity oxygen 10 through the orifice and into the gas flow path 36 wherein the internal control mechanism 38 reduces the pressure to the appropriate pressure of the portable cylinder 14. The patient P observes the regulator pressure gauge during this fill process, wherein the gauge reading will initially drop and slowly rise during the filling cycle. When the gauge stops rising, the filling cycle is complete. In one embodiment, an alert such as a timer alarm notifies the patient P when the filling cycle is complete.

During the fill process, when the portable cylinder 14 removeably connects to the valve outlet 70 to position the residual pressure valve 24 within the interior of the portable cylinder 14, the pressurized gas 10 flows through the flow channel 78 and against the first stop 102 and diaphragm member 100 to displace the first stop 102 and diaphragm member 100 against the bias member 106. The pressure of the gas flow further seats the second stop 104 within the bottom gas flow port 114. In this position of the piston assembly 76, the high pressure gas 10 flows through the side gas flow ports 116 and into the portable cylinder 14. Once the portable cylinder 14 is full as noted by a pressure gauge positioned on the exterior of the portable cylinder 14, the patient P disconnects the cylinder valve 22 from the regulator 20 so that the patient P can use the portable cylinder 14. The patient P is free to use the charged portable cylinder 14 for personal activity use. At any time, however, the patient P can also directly access the high purity oxygen 10 of the supply source 12 by connecting tubes to the bypass regulator assembly 42.

During use of the portable cylinder 14 and/or a non-fill process of the portable cylinder 14, the internal pressure of the residual pressurized gas 10 and the bias member 106, via the internal pressure, move the diaphragm member 100 out of the inserts 96 of the chamber 80 and upward in contact with the side gas flow ports 116. Additionally, the pressure of the residual pressurized gas 10 and the bias member 106 move the second stop 104 away from the bottom gas flow port 114 while seating the first stop 102 within the top gas flow port 112. As such, the seated first stop 102 and the diaphragm member 100 seal the chamber 80 from atmospheric contaminates. The residual pressurized gas 10 maintains the desired residual pressure level within the low pressure area 110 of the chamber 80. This desired residual pressure level is higher than the atmospheric pressure exposed to the exterior of the portable cylinder 14.

Once the patient P nearly exhausts the high purity oxygen 10 from the portable cylinder 14, the patient P reconnects the portable cylinder 14 to the regulator 20. Since a residual pressure of the high purity oxygen 10 remains sealed within the portable cylinder 14, atmospheric contaminants cannot enter the portable cylinder 14. As such, the patient P simply reconnects the cylinder valve 22 to the regulator 20 to repeat the fill process for the portable cylinder 14. Accordingly, the patient P can re-fill the portable cylinder 14 with high purity oxygen 10 in the home and without having to clean the portable cylinder 14. Furthermore, the patient P can re-fill the portable cylinder 14 without analyzing the purity content of the portable cylinder 14 since the residual pressure as regulated by the residual valve 24 minimizes backfill contamination between subsequent fill cycles of the portable cylinder 14.

The components of the present disclosure may be constructed of a variety of materials, including but not limited to various metals, plastics, ceramics, wood, or any other suitable material that will provide sufficient structural integrity for the each component to perform its desired function as stated herein. Each dimension of the disclosure, and thereby all of its components, may be of varying sizes. Of course, one of ordinary skill in the art will recognize that structural members may be added to strategic positions on or in the disclosure to allow the use of a variety of materials.

The detailed description above illustrates the disclosure by way of example and not by way of limitation. This description clearly enables one skilled in the art to make and use the disclosure, and describes several embodiments, adaptations, variations, alternatives and uses of the disclosure, including what I presently believe is the best mode of carrying out the disclosure. As various changes could be made in the above constructions without departing from the scope of the disclosure, it is intended that all matter contained in the above description or shown in the accompanying drawings shall be interpreted as illustrative and not in a limiting sense.

What is claimed is:

1. A system for transferring pressurized gas from a supply source to a portable cylinder comprising:
a regulator having an inlet and an outlet, the inlet being capable of removeably connecting to the supply source containing gas at a pressure above atmospheric pressure, the regulator further having a gas flow path in communication with the inlet and the outlet;
a cylinder valve capable of operative connection with the regulator and the portable cylinder, the cylinder valve having a valve inlet, a valve outlet, and a valve gas flow path in communication with the valve inlet and the valve outlet, the valve inlet being configured to removeably connect with the outlet, the valve outlet being configured to removeably connect with the portable cylinder; and
a residual pressure valve capable of operative connection with the cylinder valve, the residual pressure valve being calibrated to automatically stop the flow of the pressurized gas from the portable cylinder at a desired pressure level,
wherein during a fill cycle, the inlet of the regulator is removeably connected to the supply source, the outlet of the regulator is removeably connected to the cylinder valve inlet, the cylinder valve outlet is removeably connected to the portable cylinder such that the pressurized gas flows from the supply source through the regulator, through the cylinder valve and into the portable cylinder, the residual pressure valve thereafter retaining the desired pressure level of the residual pressurized gas in the portable cylinder to minimize backfill contamination between subsequent fill cycles of the portable cylinder.

2. The system of claim 1, further comprising a key assembly that connects together the cylinder valve and the regulator.

3. The system of claim 2, wherein the key assembly comprises a pin and a channel configured to matingly accept the pin.

4. The system of claim 1, wherein the pressurized gas comprises high purity oxygen.

5. The system of claim 4, wherein the high purity oxygen comprises a purity level of at least 93%.

6. The system of claim 5, wherein the high purity oxygen comprises a purity level of at least 99%.

7. The system of claim 1, wherein the outlet includes a check valve that prevents the flow of the pressurized gas through the outlet when the cylinder valve disconnects from the regulator.

8. The system of claim 1, wherein the regulator further comprises a regulator assembly that is configured to allow direct access to the supply source while the regulator remains connected to the supply source.

9. The system of claim 1, wherein the regulator further comprises a yoke assembly that is rotatable with respect to the valve outlet, wherein the yoke assembly rotates between a closed position and an open position such that the open position exposes the outlet for connection to the cylinder valve, and the closed position secures the cylinder valve to the outlet.

10. The system of claim 1, further comprising a chamber within the residual pressure valve, the chamber including opposing side walls, a top wall and a bottom wall wherein each wall has a gas flow port defined therethrough, the chamber further including, a piston assembly having a rod and a diaphragm member, the rod positions a first stop and a second stop at opposing ends of the rod while the diaphragm separates the chamber into a high pressure area and a low pressure area wherein during the fill cycle the portable cylinder removeably connects to the valve outlet such that the flow of the pressurized gas from the cylinder valve and into the chamber moves the first stop away from the top gas flow port to allow the flow of the pressurized gas through the side gas flow ports and into the portable cylinder.

11. The system of claim 10, wherein during a non-fill cycle pressure of the desired pressure level of the portable cylinder and the bias member move the second stop away from the bottom gas flow port and move the first stop in contact with the top gas flow port while moving the diaphragm member in contact with the side gas flow ports to seal the portable cylinder from atmospheric contaminants.

12. The system of claim 1, wherein the residual pressure valve is removeably insertable within the cylinder valve.

13. A gas transfer system comprising:
a regulator capable of operative connection to a gas supply cylinder that contains an amount of pressurized gas, the regulator comprising an inlet that is capable of removeably connecting to the gas supply cylinder, an outlet, a gas flow path in communication with the inlet and the outlet, a gas flow control mechanism in communication with the gas flow path, and a shut off valve capable of stopping the flow of pressurized gas through the flow path;
a cylinder valve capable of operative connection with a portable gas cylinder, the cylinder valve comprising a valve inlet, a valve outlet, and a valve gas flow path in communication with the valve inlet and the valve outlet, the cylinder valve inlet configured to removeably connect to the outlet; and
a residual pressure valve capable of operative connection to the cylinder valve, the residual pressure valve being positioned between the portable cylinder and the cylinder valve, the residual pressure valve comprising a residual inlet capable of operative connection with the valve outlet and comprising a residual outlet, a residual gas flow path in communication with the residual inlet and the residual outlet, a piston assembly in communication with the flow path, the piston assembly being capable of closing the residual gas flow path, the residual pressure valve further comprising a bias member associated with the piston assembly, the bias member applying a bias to the piston assembly that allows the flow of pressurized gas from the outlet and through the residual gas flow path when the pressure of the gas exceeds a desired pressure level of the portable gas cylinder,
wherein when the regulator is operatively connected to the gas supply cylinder, the cylinder valve is operatively connected to the regulator and the residual pressure valve, and the residual pressure valve is positioned within the portable gas cylinder, the gas transfer system allows for the transfer of pressurized gas from the gas supply cylinder to the portable cylinder to fill the portable cylinder while the residual pressure valve retains the desired pressure level in the portable cylinder to minimize backfill contamination of atmospheric contaminants between subsequent fill cycles of the portable cylinder.

14. The system of claim 13, further comprising a key assembly positioned between the cylinder valve and the regulator, the key assembly only allowing the connection of the cylinder valve to the regulator in a predetermined orientation and preventing the connection of at least the cylinder valve and the regulator with any devices not compatible with the key assembly.

15. The system of claim 13, wherein the high purity gas comprises high purity oxygen.

16. The system of claim 13, wherein the high purity oxygen comprises a purity level of at least 99%.

17. The system of claim 13, wherein the regulator further comprises a yoke assembly that is rotatable with respect to the outlet, wherein the yoke assembly rotates between a closed position and an open position such that the open position exposes the outlet for connection to the cylinder valve, and the closed position secures the cylinder valve to the outlet.

18. The system of claim 13, wherein the regulator outlet includes a check valve that prevents the flow of pressurized gas through the outlet when the cylinder valve and regulator are disconnected.

19. A system for transferring gas from a gas supply source to a portable gas cylinder for repeated personal use of the portable cylinder by a patient, the system comprising:
a regulator having an inlet and an outlet, the inlet being capable of removeably connecting to a supply source containing gas at a pressure above atmospheric pressure, the regulator further having a gas flow path in communication with the inlet and the outlet;
a cylinder valve capable of operative connection with the regulator and the portable cylinder, the cylinder valve having a valve inlet, a valve outlet, and a valve gas flow path in communication with the valve inlet and the valve outlet, the valve inlet being configured to removeably connect with the outlet, the valve outlet being configured to removeably connect with the portable cylinder;
a key assembly positioned between the cylinder valve and the regulator, the key assembly only allowing the connection of the cylinder valve to the regulator in a predetermined orientation and preventing the connection of at least the cylinder valve and the regulator with any devices not compatible with the key assembly;
a yoke assembly that is rotatable with respect to the valve outlet, wherein the yoke assembly rotates between a closed position and an open position such that the open position exposes the outlet for connection to the cylinder valve, and the closed position secures the cylinder/valve to the outlet; and
a residual pressure valve capable of operative connection with the portable cylinder, the residual pressure valve being calibrated to automatically stop the flow of the pressurized gas from the portable cylinder at a desired pressure level,
wherein when the regulator is operatively connected to the supply source, the cylinder valve is operatively connected to the regulator and the residual pressure valve, and the residual pressure valve is positioned within the portable gas cylinder, the gas transfer system allows for the transfer of pressurized gas from the supply source to the portable cylinder to fill the portable cylinder while the residual pressure valve retains the desired pressure level in the portable cylinder to allow a known amount of backfill contamination of atmospheric contaminants into the portable cylinder during between subsequent fill cycles of the portable cylinder.

20. A method of repeatedly filling a portable gas cylinder without the need for purging and evacuating the portable gas cylinder during each fill cycle, the method comprising:
i. connecting the portable cylinder to a supply source having a gas pressurized to a first pressure;
ii. filling the portable cylinder to a second pressure with gas from the supply source, the second pressure being less than or equal to the first pressure;
iii. removing the portable cylinder from the supply source; and
iv. exhausting the pressurized gas from the portable cylinder down to a minimum third pressure level within the portable cylinder, the third pressure being less than the second pressure but greater than atmospheric pressure, the third pressure only allowing a known amount of backfill contamination into the portable cylinder during the exhausting of the portable cylinder; and
V. repeating steps i.-iv. for a known time period.

21. The method of claim 20 wherein the first pressure has a value of 3,000 psi.

22. The method of claim 20 wherein the second pressure has a value of 2,200 psi.

23. The method of claim 20 wherein the gas comprises high purity oxygen.

24. The method of claim 23 wherein the known amount of backfill contamination comprises 1% of the amount of the high purity oxygen.

25. The method of claim 24 wherein the known time period comprises five years.

26. A method of repeatedly filling a portable gas cylinder without the need for purging and evacuating the portable gas cylinder during each fill cycle subsequent an initial fill cycle, the method comprising:
a. initially filling the portable cylinder comprising;
i. connecting a residual pressure valve to a cylinder valve, the residual pressure valve being capable of automatically stopping the flow of pressurized gas out of the portable gas cylinder when the pressure in the portable gas cylinder drops below a desired level;
ii. connecting the cylinder valve to the portable gas cylinder, the cylinder valve being capable of opening and closing to controllably allow pressurized gas to flow into and out of the portable gas cylinder;
iii. purging and evacuating the portable cylinder;
b. connecting a regulator to the cylinder valve and to a pressurized gas supply source, the regulator being capable of regulating the flow of pressurized gas from the supply source into the portable gas cylinder;
(c) opening the cylinder valve;
(d) opening the supply source;
(e) using the regulator to controllably fill the portable gas cylinder with a desired amount of pressurized gas from the supply source;
(f) closing the cylinder valve;
(g) disconnecting the portable cylinder from the regulator;
(h) opening the cylinder valve to release the pressurized gas from within the portable cylinder;
(i) allowing the residual pressure valve to stop the release of the pressurized gas from within the portable cylinder when the pressure within the cylinder drops below the predetermined desired level, the predetermined desired level being greater than atmospheric pressure, thereby minimizing the amount of backfill contamination that enters the portable cylinder between subsequent fill cycles by allowing a known amount of backfill contamination into the portable cylinder during the exhausting of the cylinder; and
(j) repeating steps b. through i.

27. The method of claim 26, wherein the pressurized gas is oxygen.

28. The method of claim 26, further comprising filling the gas supply source with high purity oxygen having a purity level of at least 93%.

29. The method of claim 28 wherein the known amount of backfill contamination comprises 1% of the amount of the high purity oxygen.

30. The method of claim 26 wherein the known amount of backfill contamination remains constant during the known time period.

31. The method of claim 30 wherein the known time period comprises five years.

32. The method of claim 26, further comprising preventing the high purity oxygen stored in the gas supply source from discharging when the cylinder valve is disconnected from the regulator.

33. The method of claim 26, further comprising connecting a regulator assembly to the regulator supply source while the regulator remains connected to the supply source.

34. The method of claim 26, further comprising interlocking the cylinder valve and regulator with a pin and channel assembly.
